(19) United States
(12) Patent Application Publication
(10) Pub. No.: US 2026/0141426 A1
(43) Pub. Date: May 21, 2026

(54) FACILITATING AUTOMATED CAMPAIGN GENERATION VIA A CAMPAIGN ORCHESTRATOR

(71) Applicant: Adobe Inc., San Jose, CA (US)

(72) Inventors: Zhenyu Yan, Cupertino, CA (US); Xiang Wu, Mountain View, CA (US); Anil Kamath, San Jose, CA (US)

(21) Appl. No.: 18/955,250

(22) Filed: Nov. 21, 2024

(51) Int. Cl. G06Q 30/0241; G06Q 30/0242; G06Q 30/0251

(52) U.S. Cl. CPC G06Q 30/0276; G06Q 30/0246; G06Q 30/0269

(57) ABSTRACT

Methods, computer systems, computer storage media, and graphical user interfaces are provided for facilitating automated generation of a campaign using a campaign orchestrator. In one implementation, a set of campaign attributes to determine for a campaign is identified based on a query. Further, an order in which to determine campaign attributes of the set of campaign attributes is identified. Thereafter, using AI technology and operational data, at least one campaign attribute is determined for the campaign in accordance with the identified order. A campaign recommendation that includes the at least one campaign attribute is provided for display via a user interface.

### BACKGROUND

A business-to-business (B2B) campaign is generally a targeted marketing initiative designed to provide products or services from one business to another. B2B campaigns may be valuable, as such campaigns help increase brand visibility, generate leads, and build strong relationships with other businesses, leading to higher conversion rates and sale volumes. Such campaigns typically involve a series of coordinated activities and communications, such as email marketing, content marketing, social media outreach, events, etc. Generating or organizing such a B2B campaign, however, can be tedious and difficult. More specifically, orchestrating a successful B2B campaign may provide challenges due to the complexity and length of the sales cycle, the involvement of multiple decision-makers, a need for highly targeted and informative content, etc.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Various aspects of the technology described herein are generally directed to systems, methods, and computer storage media for, among other things, facilitating campaign generation in an automated manner. In embodiments, a campaign, such as a B2B campaign, is generated in an efficient and effective manner based on a query. In particular, in accordance with obtaining a query (e.g., a user-provided query), a campaign orchestrator may automatically analyze various campaign data to identify a set of campaign attributes to determine and/or an order of making such determinations. Thereafter, campaign attributes can be determined for a campaign in the specified order or sequence. In this way, a campaign recommendation may be generated and, for example, provided to a user for display via a user interface. Using a campaign orchestrator to identify a set of campaign attributes to determine and/or identify an order of such determinations facilitates an efficient and effective B2B campaign generation process. For instance, the campaign data may be analyzed in a holistic manner to identify a suitable automated campaign generation process. Additionally, the determination of various desired campaign attributes is also performed in an automated manner, resulting in an efficient and effective campaign.

### BRIEF DESCRIPTION OF THE DRAWINGS

The technology described herein is described in detail below with reference to the attached drawing figures, wherein:

FIG. 1 is a block diagram of an exemplary system for facilitating automated campaign generation via a campaign orchestrator, suitable for use in implementing aspects of the technology described herein;

FIG. 2 is an example implementation for facilitating automated campaign generation via a campaign orchestrator, in accordance with aspects of the technology described herein;

FIG. 3 provides an example method for facilitating automated campaign generation via a campaign orchestrator, in accordance with embodiments described herein;

FIG. 4 provides another example method for facilitating automated campaign generation via a campaign orchestrator, in accordance with embodiments described herein;

FIG. 5 provides another example method for facilitating automated campaign generation via a campaign orchestrator, in accordance with embodiments described herein; and

FIG. 6 is a block diagram of an exemplary computing environment suitable for use in implementing aspects of the technology described herein.

### DETAILED DESCRIPTION

The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### Overview

Business-to-business (B2B) generally refers to transactions or interactions that occur between two businesses. For example, one business may provide or sell products, services, or raw materials to another business. A B2B campaign is generally a targeted marketing initiative designed to provide products or services from one business to another. B2B campaigns may be valuable as such campaigns help increase brand visibility, generated leads, and build strong relationships with other businesses, leading to higher conversion rates and sale volumes. Such campaigns typically involve a series of coordinated activities and communications, such as email marketing, content marketing, social media outreach, events, etc. Generating or organizing such a B2B campaign, however, can be tedious and difficult. More specifically, orchestrating a successful B2B campaign may provide challenges due to the complexity and length of the sales cycle, the involvement of multiple decision-makers, a need for highly targeted and informative content, etc. For example, a strong understanding of the business target audience, meticulous planning, and integration of various marketing channels to reach and engage business professionals effectively may be difficult and time consuming.

In conventional implementations, such B2B campaign generation is generally performed by an individual or team, such as a marketing team. In this regard, various individuals may perform analysis of different types of data to generate a campaign that includes identification of channels through which to communicate content, content to provide, etc. As the amount of data to analyze is extensive, identifying an optimal B2B campaign may be difficult. For example, multiple decision-makers and multiple communication channels may be available, but an individual generating a campaign may select a decision-maker and/or communication channel that is less suited for optimizing a campaign. As another example, a user may select to sell one product to a particular customer, while another product may be more suited or appealing to the customer.

Accordingly, manually creating a campaign may result in a less effective and efficient campaign. As such, unnecessary computing resources are utilized to generate undesired or underperforming campaigns, and content associated therewith. For example, computing and network resources are unnecessarily consumed in an effort to facilitate analysis of data in an effort to generate a campaign and/or to facilitate content generation associated therewith. For instance, computing resources may be used to analyze an extensive amount of data in an effort to manually generate a campaign. Further, additional computing resources may be used to generate content to correspond with a manually generated campaign. The content may then be evaluated or analyzed for effectiveness. In some cases, such evaluation or analysis may require testing the content, which also consumes various computing resources. In cases in which the content is determined to be unsuitable, the process may be iterated on to generate a new campaign and/or new content. Any number of iterations of generating campaigns and/or content may be performed, with each iteration utilizing computing resources. For instance, computer input/output operations are unnecessarily increased in order to initiate multiple variations of content and, further, to test or evaluate the content over an extended amount of time in order to evaluate success of the different content. Further, as content is communicated over a network for various testing implementations, initiating multiple content assessments over an extended period of time to obtain feedback on the corresponding content decreases the throughput for the network, increases the network latency, and increases packet generation costs. Additionally, analyzing the feedback in relation to the multiple content variations unnecessarily consumes computing resources.

As such, embodiments described herein are directed to facilitating campaign generation in an automated manner. In embodiments, a campaign, such as a B2B campaign, is generated in an efficient and effective manner based on a query. In particular, in accordance with obtaining a query (e.g., a user-provided query), a campaign orchestrator may automatically analyze various campaign data to identify a set of campaign attributes to determine and/or an order of making such determinations. Thereafter, campaign attributes can be determined for a campaign in the specified order or sequence. In this way, a campaign recommendation may be generated and, for example, provided to a user for display via a user interface. Using a campaign orchestrator to identify a set of campaign attributes to determine and/or identify an order of such determinations facilitates an efficient and effective B2B campaign generation process. For instance, the campaign data may be analyzed in a holistic manner to identify a suitable automated campaign generation process. Additionally, the determination of various desired campaign attributes is also performed in an automated manner, resulting in an efficient and effective campaign. Further, using an identified order for determining campaign attributes enables a determined campaign attribute (e.g., product) to be utilized in determining a subsequent campaign attribute, thereby resulting in a more effective campaign generated to produce more performant results.

Advantageously, a campaign, such as a B2B campaign, may be generated or created in an efficient and effective manner, resulting in a more productive campaign, such as a more effective campaign strategy and generation of more appropriate or suitable content. For example, the campaign strategy may be more effective in gaining the interest of a target audience, and generated content may align more closely with the needs of the target audience. As such, a more accurate and timely approach can be used to generate an effective campaign and result in content that is more effective and valuable, particularly to a business customer. In addition, embodiments described herein provide an intuitive user experience. In particular, in accordance with providing a query, the user is presented with an effective campaign. In this way, a suitable campaign is generated in a timely manner and may be more efficiently implemented to achieve designated goals.

Advantageously, efficiencies of computing and network resources can be enhanced using implementations described herein. In particular, using a campaign orchestrator to identify a set of campaign attributes to determine and/or an order of such determinations facilitates a comprehensive strategy for campaign generation. As such, a campaign can be effectively and efficiently generated, thereby providing for a more efficient use of computing resources (e.g., less computationally expensive, less input/output operations, higher throughput and reduced latency for a network, less packet generation costs, etc.) than conventional methods that may result in, among other things, manual campaign generation and/or content generation that may require an extensive duration for testing and/or a manual analysis thereof, which is exacerbated with the repetitive cycles that may be required to attain an effective campaign. As a more effective campaign generation is performed in accordance with embodiments herein, unnecessary use of computing resources to generate, initiate, and analyze various campaign iterations is reduced. Moreover, the technology described herein enables identification of particular campaign attributes needed for an effective campaign and an order in which to make such determinations. Such an orchestration results in a more efficient process, as such determinations are performed in a manner that corresponds with an input query and results in performing only such campaign attribute determinations needed to generate an effective campaign. Further, such an orchestration facilitates a more comprehensive evaluation of data, thereby resulting in generation of a more effective campaign. As such, embodiments described herein enable a more computing resource-efficient implementation for generating a campaign.

Various terms are used throughout the description of embodiments provided herein. A brief overview of such terms and phrases is provided here for ease of understanding, but more details of these terms and phrases are provided throughout.

A campaign generally refers to a plan or set of actions and messages designed to achieve a particular goal or objective. In embodiments, the goal may be related to a financial or marketing goal, such as raising awareness, promoting a product or service, increasing sales, encouraging a particular behavior or outcome, etc.

A B2B campaign generally refers to a strategic effort to promote products or services from one business to another. In this regard, a B2B campaign focuses on reaching decision-makers within other businesses or accounts. Accordingly, such campaigns are directed to building relationships, generating leads, and driving sales based on specific needs and challenges of a target business audience. Key components of a B2B campaign may include identifying a target business or account, selecting a product or service to promote, selecting effective communication channels, developing tailored content, engaging with key contacts or decision-makers, etc.

A campaign attribute generally refers to elements or characters that facilitate defining and shaping a campaign, such as a B2B campaign. Various campaign attributes may include a goal, an offering (e.g., a product or service), an account, a contact, a channel, a content, a post-sales activity, and/or the like.

A campaign orchestrator generally refers to a component or tool used to plan, coordinate, and/or manage generation or a campaign, or campaign attributes associated therewith. In embodiments, the campaign orchestrator ensures that campaign attributes are aligned and executed seamlessly to achieve an objective.

Content generally refers to any content that may be generated. Content may be in the form of text, images, video, audio, etc. For example, content may be in the form of articles, blog posts, books, social media updates, emails, images, infographics, videos, illustrations, podcasts, music, audiobooks, etc. In some cases, content is or includes campaign content, which may be any content or material related to a campaign. Generally, campaign content may include material or messaging provided to an audience or individuals to engage, persuade, and/or encourage an action. Examples of campaign content include messages, slogans, visual branding (e.g., logos, colors, fonts, etc.), advertisements (e.g., commercials, videos, online advertisements, printed materials, images, etc.), storytelling content, social media content (e.g., blog posts, articles, etc.), videos, text, images, etc.

### Overview of Exemplary Environments for Facilitating Automated Campaign Generation Via a Campaign Orchestrator

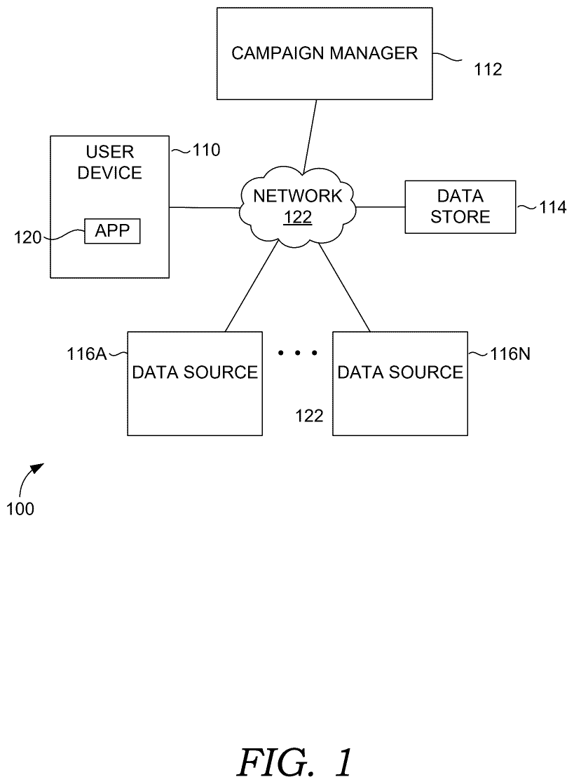

Referring initially to FIG. 1, a block diagram of an exemplary network environment 100 suitable for use in implementing embodiments described herein is shown. Generally, the system 100 illustrates an environment suitable for facilitating automated campaign generation via a campaign orchestrator. In embodiments, a campaign orchestrator generally manages the identification of campaign attributes for a campaign based on operational data. In particular, a campaign orchestrator may identify campaign attributes to determine as well as a timing or order for doing so. Among other things, embodiments described herein effectively and efficiently generate campaign recommendations, including any number of campaign attributes determined using operational data. In this regard, a B2B campaign can be generated and executed in an efficient and effective manner to advance or attain a goal(s) associated with a campaign. As campaign attributes are identified effectively and efficiently and in accordance with operational data, the generation of a campaign is performed efficiently, thereby reducing the computing resource utilization that would otherwise be used to iteratively generate or execute a campaign to obtain a desired outcome and/or perform testing of various campaign attributes (e.g., content) over an extensive testing period.

In operation, a user, such as a marketer, can input or provide a query and, based on the input, be automatically provided with one or more campaign recommendations related to the query. In embodiments, a query may include a goal, a target audience segment or attributes, a company identity, a brand identity, a product identity, data associated therewith, and/or the like. The resulting generated campaign recommendations may be generated in a manner that is suitable to attain a desired performance or effectiveness of execution of the campaign, or a portion thereof. As described herein, various operational data may be identified as relevant to a query and/or a particular campaign attribute being generated and, thereafter, used to determine the campaign attribute.

The network environment 100 incorporates the generation of campaign recommendations in an environment or system that may use artificial intelligence (AI) technology. In FIG. 1, the network environment includes a user device 110, a campaign manager 112, a data store 114, and data sources 116a-116n (referred to generally as data source[s] 116). The user device 110, the campaign manager 112, the data store 114, and the data sources 116a-116n can communicate through a network 122, which may include any number of networks such as, for example, a local area network (LAN), a wide area network (WAN), the Internet, a cellular network, a peer-to-peer (P2P) network, a mobile network, or a combination of networks.

The network environment 100 shown in FIG. 1 is an example of one suitable network environment and is not intended to suggest any limitation as to the scope of use or functionality of embodiments disclosed throughout this document, and nor should the exemplary network environment 100 be interpreted as having any dependency or requirement related to any single component or combination of components illustrated therein. For example, the user device 110 and data sources 116a-116n may be in communication with the campaign manager 112 via a mobile network or the Internet, and the campaign manager 112 may be in communication with data store 114 via a local area network. Further, although the environment 100 is illustrated with a network, one or more of the components may directly communicate with one another, for example, via HDMI (high-definition multimedia interface) and DVI (digital visual interface). Alternatively, one or more components may be integrated with one another; for example, at least a portion of the campaign manager 112 and/or data store 114 may be integrated with the user device 110 and/or data sources 116. For instance, a portion of the campaign manager 112 may be integrated with a server in communication with a user device 110 and/or data sources 116, while another portion of the campaign manager 112 may be integrated with the user device 110 and/or data sources 116.

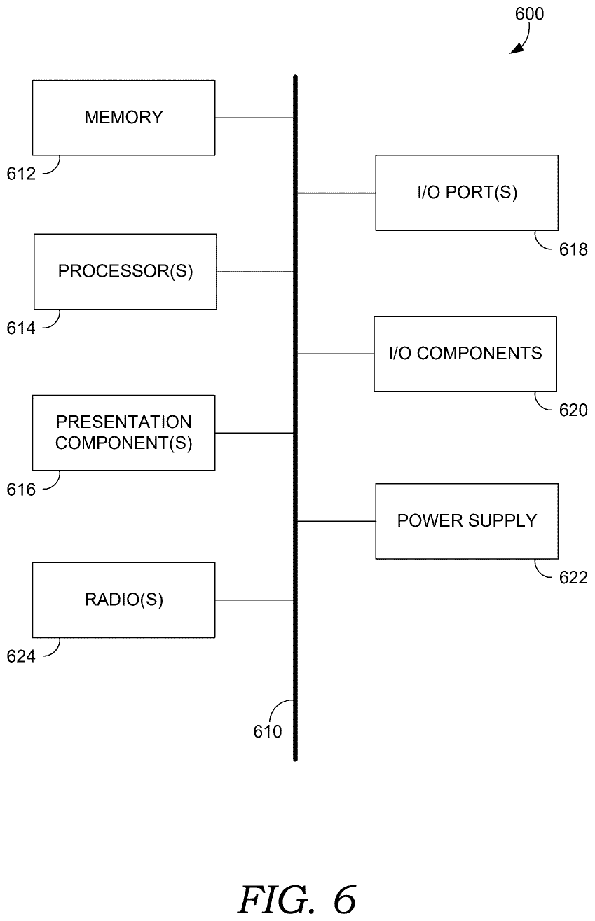

The user device 110 and the data sources 116 can be any kind of computing device capable of facilitating campaign generation, such as B2B campaign generation, in an automated manner or workflow. For example, in an embodiment, the user device 110 and/or data sources 116 can be a computing device such as computing device 600, as described above with reference to FIG. 6. In embodiments, the user device 110 and/or data sources 116 can be a personal computer (PC), a laptop computer, a workstation, a mobile computing device, a personal digital assistant (PDA), a cell phone, or the like. Although illustrated separately, in some cases, the functionality described in association with the user device 110 and the data sources 116 may be performed via a single device (e.g., the user device also provides the query[s]).

The user device 110 and/or the data sources 116 can include one or more processors and one or more computer-readable media. The computer-readable media may include computer-readable instructions executable by the one or more processors. The instructions may be embodied by one or more applications, such as application 120 shown in FIG. 1. The application(s) may generally be any application capable of facilitating campaign generation. In some cases, the application(s), such as application 120, may facilitate providing a query, for example in association with a campaign. In some implementations, the application(s) comprises a web application, which can run in a web browser, and could be hosted at least partially server-side (e.g., via campaign manager 112). In addition, or instead, the application(s) can comprise a dedicated application. In some cases, the application is integrated into the operating system (e.g., as a service). As one specific example application, application 120 may be a content management tool and/or analytics tool (e.g., Adobe® Experience Manager or Adobe® Analytics), or a portion thereof, that enables creation, management, delivery, and/or analysis of content and digital assets. In some cases, such digital experiences may be provided across various channels, such as websites, mobile apps, forms, electronic communications, etc. Application 120 may be accessed via a mobile application, a web application, or the like.

User device 110 can be a client device on a client-side of operating environment 100, while campaign manager 112 can be on a server-side of operating environment 100. Campaign manager 112 may comprise server-side software designed to work in conjunction with client-side software on user device 110 so as to implement any combination of the features and functionalities discussed in the present disclosure. An example of such client-side software is application 120 on user device 110. Alternatively, the user device 110 may include server-side software. This division of operating environment 100 is provided to illustrate one example of a suitable environment, and it is noted that there is no requirement for each implementation that any combination of user device 110, campaign manager 112, and/or data source 116 to remain as separate entities.

In an embodiment, the user device 110 and/or data source 116 is separate and distinct from the campaign manager 112 and the data store 114 illustrated in FIG. 1. In another embodiment, the user device 110 and/or data source 116 is integrated with one or more illustrated components. For instance, the user device 110 and/or data source 116 may incorporate functionality described in relation to the campaign manager 112. For clarity of explanation, embodiments are described herein in which the user device 110, the campaign manager 112, the data store 114, and the data sources 116 are separate, while understanding that this may not be the case in various configurations contemplated.

As described, a user device, such as user device 110, can facilitate providing a query to campaign manager 112 and, in response, view campaign recommendations generated in association with the query. Advantageously, the campaign attributes of the campaign recommendations are generated using operational data identified as relevant to the query and/or campaign attribute being generated, such that the campaign attribute is more aligned or suitable in relation to the query and/or an effective campaign. A user device 110, as described herein, may be operated by an individual or set of individuals that desires to view campaign recommendations, for example, generated for a campaign. As one example, a user device may be operated by a campaign manager or marketing manager. Such an individual may be affiliated with or a representative of a company associated with the campaign.

In some cases, generation of campaign recommendations in association with a campaign(s) may be initiated at the user device 110. For example, a user, such as an administrator or campaign manager, may input, provide, or select a query. For instance, a user may input or select, via a user interface, a query associated with a campaign. In some cases, a user may provide a goal, an objective, a target audience, a target channel, a content type, etc., and/or an indication thereof. Such data may be provided via a text input box. The query may include any type of data associated with a desired campaign.

Although only a single user device 110 is illustrated in FIG. 1, any number of user devices may operate in this environment. For example, a first user device may provide a first query in association with a first campaign, while a second user device may provide a second query in association with a second campaign.

An input or selection of a query can be provided via an application 120 operating on the user device 110. In this regard, the user device 110, via an application 120, might allow a user (e.g., an administrator) to input, select, or otherwise provide a query. The application 120 may facilitate the inputting of query data in a verbal form, a textual input form, a document form, etc. Such a query may be input at the user device 110 in any manner. For instance, upon accessing a particular application (e.g., a campaign management application), a user may be presented with, or navigate to, an input tool to input a query (e.g., via text input).

The user device 110 can communicate with the campaign manager 112 to provide the query and/or request generation of a campaign recommendation, or campaign attributes(s) associated therewith. In embodiments, for example, a user may utilize the user device 110 to provide a query via the network 122. For instance, in some embodiments, the network 122 might be the Internet, and the user device 110 interacts with the campaign manager 112 to provide a query for use in generating a campaign recommendation(s). In other embodiments, for example, the network 122 might be an enterprise network associated with an organization. It should be apparent to those having skill in the relevant arts that any number of other implementation scenarios may be possible as well.

The data sources 116 are generally configured to provide data for use by the campaign manager 112, for example, to generate a campaign recommendation. As described, a data source may provide any type of data. In some cases, a data source may include proprietary data and/or third-party data. For example, product details may be proprietary data provided by data source 116A, while data source 116N may provide third-party social media data. Any number of data sources may operate in this environment. For example, a first data source may provide a first set of data, while a second data source may provide a second set of data. In embodiments, the data may be provided to the data store 114 such that the data store 114 collects the data for reference or use by the campaign manager 112.

The data sources 116 can communicate with the campaign manager 112, data store 114, or other component to provide data. In embodiments, for example, the network 122 might be the Internet, and the data sources 116 interact with the campaign manager 112 and/or data store 114 to provide various types of data for use in, among other things, generating campaign recommendations. In other embodiments, for example, the network 122 might be an enterprise network associated with an organization. It should be apparent to those having skill in the relevant arts that any number of other implementation scenarios may be possible as well.

With continued reference to FIG. 1, the campaign manager 112 can be implemented as server systems, program modules, virtual machines, components of a server or servers, networks, and the like. At a high level, the campaign manager 112 manages generation of a campaign, or campaign attributes associated therewith. In operation, and at a high level, the campaign manager 112 can obtain a query, for example, from user device 110. Based on the query, a campaign orchestrator may identify a set of campaign attributes to determine an order or timing in which to determine the campaign attributes. Thereafter, one or more campaign attributes may be determined, for example, using various operational data. In accordance with identifying campaign attributes, the campaign attributes may be used to generate or provide a campaign recommendation, for example, to a user device for display to a user. In some cases, the campaign recommendation may then be presented and/or used to present results via a user interface, for example, of the user device 110. Such campaign recommendations can additionally or alternatively be transmitted to data store 114 for access by any component managing or executing a campaign. Advantageously, utilizing implementations described herein enables generation of a campaign, or a portion thereof, to be performed in an efficient and accurate manner in accordance with operational data.

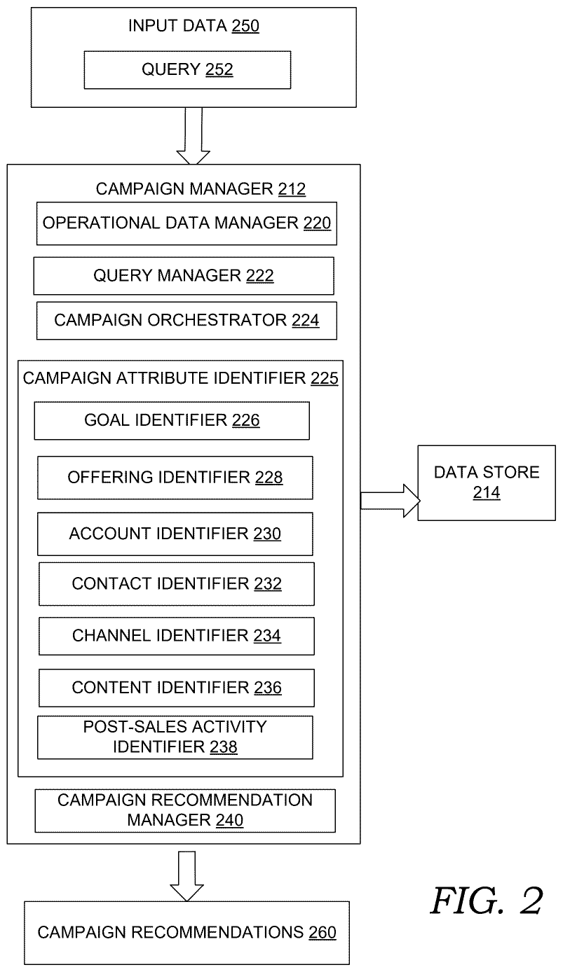

Turning now to FIG. 2, FIG. 2 illustrates an example implementation for facilitating management of campaign generation, such as a B2B campaign. The campaign manager 212 can communicate with the data store 214. The data store 214 is configured to store various types of information accessible by the content generation campaign manager 212, or another server or component. In embodiments, user device (such as user device 110 of FIG. 1), data sources (such as data sources 116 of FIG. 1), and campaign manager 212 can provide data to the data store 214 for storage, which may be retrieved or referenced by any such component. As such, the data store 214 may store queries, operational data, campaign attributes, campaign recommendations, and/or the like.

In operation, the campaign manager 212 is generally configured to facilitate or manage generation of a campaign, and/or campaign attributes associated therewith, using operational data in an efficient and effective manner. In particular, the campaign manager 212 manages generation of campaigns using a campaign orchestrator that facilitates identifying a set of campaign attributes to determine for a campaign and/or an order in which to perform such determinations. In this way, campaigns may be generated in an efficient and effective manner. In embodiments, the campaign manager 212 includes an operational data manager 220, a query manager 222, a campaign orchestrator 224, a campaign attribute identifier 225, and a campaign recommendation manager 240. According to embodiments described herein, the campaign manager 212 can include any number of other components not illustrated. In some embodiments, one or more of the illustrated components 222, 224, 225, and 240 can be integrated into a single component or can be divided into a number of different components. Components 222, 224, 225, and 240 can be implemented on any number of machines and can be integrated, as desired, with any number of other functionalities or services.

The operational data manager 220 is generally configured to manage operational data for use in generating a campaign. The operational data manager 220 may obtain or collect various types of operational data. In embodiments, the operational data manager may obtain operational data used to generate a campaign, such as a B2B campaign. Operational data generally refers to any data that may be used in generating a campaign. By way of example only, “operational” may refer to information or data generated and/or collected in association with a business. Operational data may be used for managing business processes, tracking transactions and sales, supporting decision-making, etc. Such data may include details related to sales, inventory, customer interactions, and financial transactions. In embodiments, operational data may include data associated with any number of businesses or organizations.

Examples of such operational data may include product data, engagement data, firmographics, brand data, customer data, and/or the like. Product data may relate to any data in association with a product. For example, product data may include price, product type, product features, product benefits, product availability, sales pitch documents, customer feedback, etc. Product data may include information about products a company or business had bought, such as a purchase history, product specifications, and usage patterns. Engagement data generally refers to any data, behaviors, or metrics indicating engagement with a product or brand (e.g., clicks, user interactions, feedback, purchases, etc.). Engagement data may indicate how a business interacts with a product or service, including usage frequency, feature adoption, customer support interactions, etc. Firmographics may include details pertaining to an organization's size, industry, revenue, location, organizational structure, products, services, purchasing history, engagements with other businesses, etc. Brand data generally refers to any data associated with a brand, such as a brand identity, brand features, brand values, etc. Customer data generally refers to any data associated with customers (e.g., of a brand, product, or company). Customer data generally refers to any data regarding a customer or customers. Customer data within a dataset may include, by way of example and not limitation, data that is sensed or determined from one or more sensors, such as location information of mobile device(s), smartphone data (such as phone state, charging data, date/time, or other information derived from a smartphone), activity information (for example: app usage; online activity; searches; browsing certain types of webpages; listening to music; taking pictures; voice data such as automatic speech recognition; activity logs; communications data including calls, texts, instant messages, and emails; website posts; other user data associated with communication events) including activity that occurs over more than one device, user history, session logs, application data, contacts data, calendar and schedule data, notification data, social network data, news (including popular or trending items on search engines or social networks), online gaming data, ecommerce activity, including customer journey data, sports data, health data, customer firmographics, customer's geographical location, economic status, or any other relevant data collected regarding the customer, and nearly any other source of data that may be used to identify the customer. In embodiments, the customer is a business.

Operational data may be obtained in association with various businesses. In this way, product data, engagement data, firmographics, etc., may be obtained in association with multiple businesses.

Such operational data may be obtained via various data sources. Examples of data sources that may include or provide data include product databases, internal documentation, marketing materials, customer relationship management (CRM) systems, surveys and feedback, behavioral data, analytics platforms, websites (e.g., business websites), business directories, public records, social media profiles, market research reports, etc. By way of example, product data may include information about product features, which may be stored in product databases or product information management (PIM) systems. Such databases may contain detailed descriptions, specifications, and updates about the products. Internal documents, such as product manuals, feature lists, and development notes, may provide comprehensive details about the features of each product. Marketing materials may include brochures, product pages on the company's website, and marketing campaigns that describe product features and benefits. CRM systems may store detailed information about customer preferences, purchase history, and interactions with the company. Customer surveys, feedback forms, and reviews provide direct insights into user preferences and satisfaction levels. Behavioral data may reflect data collected from user interactions with the company's website, mobile apps, and other digital platforms, which may reveal preferences based on browsing history, click patterns, and purchase behavior. Analytics platforms may track user engagement metrics such as page views, time spent on site, click-through rates, and conversion rates. Social media platforms provide engagement metrics such as likes, shares, comments, and follower growth. Email marketing tools may track metrics such as open rates, click rates, and unsubscribe rates, providing insights into how users engage with email content. Such data, among other types of data, may be obtained through data ingestion processes (e.g., via APIs, data pipelines, batch processing, etc.).

The operational data manager 220 may obtain operational data in any of a number of ways. In some cases, operational data manager 220 may obtain operational data in an automated manner. For example, a data source(s) and/or data store(s) may be configured to provide data on a periodic basis or upon an occurrence of an event. For instance, data may be obtained (e.g., received, retrieved, or accessed) via a data source, such as data sources 116 of FIG. 1. As another example, a user of a user device may provide a request that triggers the operational data manager 220 to obtain data. For instance, based on a user request, the operational data manager 220 may access or retrieve data from one or more data sources and/or data stores.

Such obtained operational data may be stored, for example, in a data store, such as data store 214. Data may be stored, for instance, in a database or an index that enables efficient retrieval. In some embodiments, operational data may be stored in association with corresponding metadata. Such metadata may include information associated with the data, such as identifiers, attributes (e.g., author, category, performance metrics, date of creation, etc.), data type, source information (e.g., details about the source of the data), references or information that links to the data, etc. Such data may be consolidated into a single storage platform to enable more efficient and comprehensive data analysis.

In some embodiments, the operational data manager 220 may preprocess the operational data. In this regard, the operational data manager 220 may ensure the data is clean, consistent, and/or in a suitable format for analysis or further processing. Such preprocessing may include data cleaning, data transformation, data integration, data reduction, data enrichment, etc. As one example, the operational data manager 220 may transform firmographic data, or a portion thereof, into a hierarchical information structure. As one example, the hierarchical information structure may include a business or account level, which may have sub-account levels corresponding to different regions. Each account may include individual contacts to facilitate an understanding of relationships with the business. Other data included in a hierarchical data structure may include which businesses or contacts are currently using a product(s), engagement history with the contacts (e.g., past interactions, such as meetings, electronic communications, etc.), etc. Any data structure may be used to aggregate various types of data, and embodiments herein are not intended to be limited to a hierarchical data structure.

The query manager 222 is generally configured to manage queries provided to search for data. A query generally refers to a request for information or data. In some cases, a query may be input by a user, for example, via a text input box. In this regard, the query manager 220 may obtain a query 252 as input data 250. As described, in some embodiments, a query may be obtained via a user, such as user device 110 of FIG. 1. In this regard, a user (e.g., B2B marketer) may provide a query via a user interface of the user device, which then provides the query to the campaign manager 212 (e.g., via a network). In some cases, a query may be input, uploaded, or selected via a user interface. Alternatively or additionally, a query may be computer-generated. In this way, a computer may generate a query and provide the query to the campaign manager (e.g., via a network).

In some embodiments, a query may include an indication of a desired campaign. As described, a campaign generally refers to a plan or set of actions and messages designed to achieve a particular goal or objective. As such, a query may include any data that indicates a goal, a target audience, a message, a channel, a tactic, a measurement, a timing, a messaging tone, etc., associated with a campaign. A goal may refer to any goal or objective associated with a campaign. Examples of goals may include increasing sales for a particular product, retaining customers (e.g., B2B customers), encouraging product use to increase opportunities for renewing subscriptions, etc. A target audience generally refers to a particular group or segment of customers (e.g., businesses) the campaign is intended to reach. A message may refer to an idea or value the campaign communicates to inspire or encourage action or interest by an audience member. A channel generally refers to a platform or medium used to deliver a campaign content(s) (e.g., social media, email, television, print, etc.). A tactic may include specific actions or variations that make up a campaign. A measurement may include a metric or key performance indicator used to track the success of a campaign, or a portion thereof. A timing may indicate when campaign content is to be delivered to customers, when a campaign action is to be performed, etc. A messaging tone refers generally to the tone of the message or campaign content.

In some cases, a query may include content, such as campaign content related to a campaign. Generally, campaign content may include material or messaging provided or a candidate content to be provided to an audience, individuals, or business to engage, persuade, and/or encourage an action. Content, such as campaign content, may take on any of a number of forms. In embodiments, content is in the form of a content item, such as an image and/or text, that conveys or portrays a message, product, item, etc. Examples of content include messages, slogans, visual branding (e.g., logos, colors, fonts, etc.), emails, advertisements (e.g., commercials, videos, online advertisements, printed materials, images, etc.), storytelling content, social media content (e.g., blog posts, articles, etc.), videos, text, images, etc.

Initially, the query manager 222 obtains a query. A query may be obtained in any number of ways. In some cases, as described, a query may be obtained by a user device, such as user device 110 of FIG. 1. In other cases, a query may be obtained from a data store, such as data store 214, or another computing device.

In embodiments, the query manager 222 processes the query. In this regard, the query manager 222 may parse the query to break down the query to constituent parts to understand its structure and meaning. For example, parsing a query may enable identification of key elements such as the main subject, any specific details, and the type of information or response being requested. In association with parsing, key terms or elements may be identified or extracted. For instance, the subject, specific details, and/or desired format of response may be identified. For instance, assume a query is about a specific product, the product name, product features, and what kind of information the user is seeking may be identified. The context of the query may also be considered. For example, implicit information based on previous interactions or general knowledge about a topic may be identified.

In some embodiments, upon parsing and identifying elements, the query may be optimized in various manners. For example, redundancies may be identified and removed. As another example, expressions may be simplified. In this way, more complex phrases may be reduced to simpler, more direct expressions. As another example, focus may be on key elements. As such, extraneous information that does not contribute to the core request may be removed. As yet another example, components of the query may be rephrased for clarity and/or ambiguities removed. The resulting query may be used to perform or execute a request for information.

The campaign orchestrator 224 is generally configured to manage identifying a set of campaign attributes to determine for a campaign and/or an order in which to perform such determinations. A set of campaign attributes may be determined in any number of ways. In embodiments, a set of campaign attributes to determine for a campaign may be identified based on a query. For example, assume a query requests identification of a target business for a particular product. In such a case, the campaign orchestrator 224 may identify a business campaign attribute to be determined. In this regard, a desired or target campaign attribute to determine may be identified based on the intent or request provided in the query. In other cases, a set of campaign attributes to determine for a campaign may be identified based on campaign attributes omitted in the query. For instance, assume a query includes an indication of a particular business to which to sell a particular product. In such a case, as the business and the product are identified in the query, the campaign orchestrator 224 may identify a channel, a decision-maker, and content as campaign attributes to determine.

In addition to using a query, the campaign orchestrator 224 may identify campaign attributes to determine for a campaign based on analysis of operational data. In this regard, the campaign orchestrator 224 may analyze various operational data. In some cases, an overall data analysis may be performed. In other cases, a specific set of operational data may be analy zed to identify campaign attributes to determine for a campaign. For example, surveys can provide insights, issues, or needs, indicating whether identifying a product or content strategy should be a focus.

Additionally or alternatively, the campaign orchestrator 224 may identify campaign attributes to determine for a campaign based on an occurrence of an event. As one example, assume a product sale is completed. In such a case, the campaign orchestrator 224 may be used to determine an updated campaign, such as post-sales activities, to use to ensure a smooth transition to the product or to retain the customer.

The campaign orchestrator 224 may further identify an order in which to determine campaign attributes. Identifying an order or sequence for which to determine campaign attributes may be performed in any number of ways. In some cases, an order may be determined based on a desired order indicated in the query. For example, a query may indicate a preference or order for at least a portion of the campaign attributes. In other cases, a predetermined order or template order may be used to identify an order. In this way, the order for determining campaign attributes may follow a particular order, with various campaign attributes skipped in cases in which the campaign attribute is already identified (e.g., via a query). For example, assume an order is predetermined to be a product, a business, a decision-maker, a channel, and a content. Further assume the query indicates a desire to sell to a particular business. In such a case, the product may be determined, followed by the decision-maker, the channel, and the content, respectively. As can be appreciated, various predetermined orders or sequences may exist and be used. For example, different predetermined orders may be generated based on different campaign attributes being indicated in the query. For instance, in cases in which a product is specified in the query, a first predetermined order may be accessed and used, and in cases in which a business is specified in the query, a second predetermined order may be accessed and used.

Alternatively or additionally, the campaign orchestrator 224 may identify an order for determining campaign attributes based on analysis of operational data. In this regard, the campaign orchestrator 224 may analyze various operational data. For example, data related to which types of content (e.g., blogs, videos, whitepapers, etc.) correspond with the most engagement may indicate whether content should be a priority. As another example, understanding how competitors position their products and which channels are used may help determine if such campaign attributes should be prioritized. Feedback from customers may also indicate whether prioritizing a product or content should be a focus. Further, in some embodiments, an order for determining campaign attributes may be based on an occurrence of an event (e.g., an initial engagement with a potential customer, an interest in the product taken by a potential customer, a completion of a sale, etc.).

The campaign orchestrator 224 may, in some cases, identify a timing for determining a set of campaign attributes. For example, a particular date or a preceding occurrence of an event may be specified to indicate a timing for determining a campaign attribute.

In some embodiments, the campaign orchestrator 224 may use AI technology to identify a set of campaign attributes to determine and an order for doing so. For example, the campaign orchestrator 224 or other component (e.g., a portion of the campaign orchestrator or a component accessible by the campaign orchestrator) may learn from prior campaign generations. For example, an AI system can analyze recorded communications, such as emails and calls, to identify patterns and insights. For instance, by examining the number of emails sent, the timing, the content discussed, and the tone used, the AI can understand effective communication strategies and can create campaign workflows based on such interactions.

In embodiments, in accordance with identifying a set of campaign attributes to determine and an order for doing so, the campaign orchestrator 224 may manage the sequence and timing of such determinations. In this regard, the campaign orchestrator 224 may ensure that each task is triggered at the appropriate time and/or in a determined order.

In embodiments, the campaign orchestrator 224 may perform such an identification of a set of campaign attributes to determine and/or an order thereof in a batch manner. In this way, upon obtaining a query, the campaign attributes and order for determining such campaign attributes may be identified before the campaign attribute determinations are made. In other examples, the campaign orchestrator 224 may identify campaign attributes and/or an order thereof in a sequential manner. In this way, a first campaign attribute to determine may be identified and, based on a corresponding result, a second campaign attribute to determine may be identified. In this way, the particular campaign attributes and/or order may be adaptively determined based on prior identifications of campaign attributes and/or performing an action in association with a prior identification of a campaign attribute. For example, data indicating a lack of a response to an email may result in a new campaign attribute determination for another communication channel or a different decision-maker. As another example, data indicating a customer didn't like a product may result in a new campaign attribute determination for a different product. As yet another example, post-sales activities may not be identified until a sales event has occurred.

As described, various campaign attributes may be determined for a campaign. Accordingly, the campaign attribute identifier 225 may facilitate identification of various campaign attributes. Example campaign attribute identification components for identifying various campaign attributes are described below with respect to a goal identifier 226, an offering identifier 228, an account identifier 230, a contact identifier 232, a channel identifier 234, a content identifier 236, and a post-sales activity identifier 238. Any number or type of campaign attribute identifiers may be used. Such components are described separately for purposes of explanation, but any number or type of components may be used to facilitate determinations of campaign attributes for a campaign. Further, the implementation or operation of any of such components may be performed in any order or manner. For example, utilization of which components and in which order may be managed by the campaign orchestrator 224.

The goal identifier 226 is generally configured to identify a goal for a campaign. A goal may be directly requested in a query and/or identified as a campaign attribute to determine via the campaign orchestrator 224. In embodiments, to identify a goal for a campaign, various operational data may be analyzed. In some cases, statistical and analytical tools may be used to identify patterns and trends in the data. For example, an identification of which products are selling well and which channels are most effective may be relevant to identifying a goal for a campaign. In addition, customer insights such as examining customer behavior and preferences to understand what drives engagement and conversions may be valuable for determining a goal. An overall business strategy or objectives may be considered or used to ensure that the campaign goal aligns therewith.

Such data may be used to determine a goal. In some cases, AI technology may be used to analyze the data and provide a goal recommendation. In this regard, the goal identifier 226 may generate a prompt that includes data relevant to determining a goal. For example, a query, or portion thereof, and an instruction to determine a goal may be provided in a prompt. In addition, in some cases, additional data, such as a portion of operational data, may be included in the prompt to provide context. For instance, product data and customer insights may be included in a prompt to determine a goal.

The offering identifier 228 is generally configured to identify an offering to provide (e.g., sell). An offering may be a product and/or service that may be provided to a customer or potential customer. For example, in some cases, an account to which to sell may be identified (e.g., via a query or via an account identifier). In such cases, the offering identifier 228 may identify which product and/or service to sell thereto. An offering determination may be directly requested in a query and/or identified as a campaign attribute to determine via the campaign orchestrator 224.

In embodiments, to identify an offering for a campaign, various operational data may be analyzed. For example, sales performance data may be accessed and analyzed. For instance, past sales data may be analyzed to identify which product(s) has been most successful. Metrics such as revenue, units sold, and sales growth may be analyzed. Further, the length and complexity of the sales cycle may be analyzed for different products to understand which ones close faster and more efficiently. Engagement metrics and customer feedback may also be analyzed. For example, customer interactions (e.g., open rates, click-through rates, responses, etc.) may be analyzed to determine which products generate the most interest. Feedback, such as surveys, reviews, and support tickets, may be analyzed to identify issues, problems, or preferences. Marketer and competitor analysis data may also be analyzed or considered. For example, industry reports and market research may be performed to understand trends and demands. Gaps in the market may be identified such that a product may be selected to fill the gap. Competitor offerings may also be analyzed to identify opportunities for product differentiation. Product usage data may be analyzed to identify which features or products are most used and which ones are most valuable to customers. Other data may be analyzed, including, but not limited to profit margins, product lifecycles, etc.

Such data may be used to determine an offering(s). In some cases, AI technology may be used to analyze the data and provide an offering(s) recommendation. In this regard, the offering identifier 228 may generate a prompt that includes data relevant to determining an offering. For example, a query, or portion thereof, and an instruction to determine an offering may be provided in a prompt. In addition, in some cases, additional data, such as a portion of operational data, may be included in the prompt to provide context. For instance, product usage data (e.g., in association with a particular account or any number of accounts) may be included in a prompt to determine an offering.

The account identifier 230 is generally configured to identify an account(s) to which to sell or interact. An account may refer to a business or organization that a company is targeting, engaging with, or managing as a customer or a potential customer. For example, in some cases, a product to sell may be identified (e.g., via a query or via an offering identifier). In such cases, the account identifier 230 may identify which account to engage with or sell thereto. An account determination may be directly requested in a query and/or identified as a campaign attribute to determine via the campaign orchestrator 224.

In embodiments, to identify an account(s) for a campaign, various operational data may be analyzed. For example, sales performance data may be accessed and analyzed. For instance, past sales data may be analyzed to identify which account(s) has high past sales or significant growth potential. Metrics such as revenue, units sold, and sales growth may be analyzed. Further, the length and complexity of the sales cycle may be analyzed for different accounts to identify accounts to prioritize with shorter cycles. Engagement metrics and customer feedback may also be analyzed. For example, analyzing data on how accounts interact with marketing efforts may be valuable. In this way, customer interactions (e.g., open rates, click-through rates, responses, website visits, etc.) may be analyzed. As another example, support tickets may be analyzed to identify the frequency and nature of support tickets, such that account needs and satisfaction levels may be taken into consideration. Account informatics may also be analyzed in identifying an account for a campaign. For instance, an account(s) may be identified in cases in which it focuses within an industry(s) that aligns with desired product offerings and/or in cases in which the business is a size that matches a target market. Market position may be identified and analyzed to identify accounts that are leaders or emerging players in an industry. Competitor engagement may be analyzed to identify accounts engaged with competitors (e.g., to identify potential opportunities for conversion). Product data, such as usage data and product feedback, may also be analyzed. For example, current accounts using a target product(s) may be analyzed to identify similar accounts that may benefit. Feedback and reviews may provide an understanding of which product(s) are most valued by different types of accounts.

Profitability may also be taken into account. For example, accounts that contribute significantly to revenue or do not contribute significantly to revenue may be identified. In addition, product lifecycle may be analyzed to determine which accounts may adopt new products or features and/or which accounts have renewal rates indicating long-term potential. Behavioral data and/or social media data may also be analyzed. For example, website analytics may be analyzed to identify a high-interest account and/or content engagement may be analyzed to identify an account that engages with content (e.g., downloads, webinar attendance, etc.). Social media data may be analyzed to identify social media mentions and interactions to identify accounts expressing an interest in a target industry or product, etc. Any additional data may be analyzed, and embodiments are not intended to be limited herein.

Such data may be used to determine an account(s) with which to engage in association with a campaign. In some cases, AI technology may be used to analyze the data and provide an account(s) recommendation. In this regard, a predictive model may be used to forecast which accounts are most likely to convert or grow, or a machine learning model may be used to determine an account to target. In one example, the account identifier 230 may generate a prompt that includes data relevant to determining an account. For example, a query, or portion thereof, and an instruction to determine an account may be provided in a prompt. In addition, in some cases, additional data, such as a portion of operational data, may be included in the prompt to provide context. For instance, product usage data, firmographics data, etc., may be included in a prompt to determine an account.

The contact identifier 232 is generally configured to identify a contact(s) associated with an account(s) with which to sell or interact. A contact may refer to an individual (e.g., decision-maker) in a business or organization that a company is targeting, engaging with, or managing as a customer or a potential customer. For example, in some cases, an account to which to sell a product may be identified (e.g., via a query or via an account identifier). In such cases, the contact identifier 232 may identify which individual associated with the account to engage with or sell thereto. A contact determination may be directly requested in a query and/or identified as a campaign attribute to determine via the campaign orchestrator 224.

In embodiments, to identify a contact(s) for a campaign, various operational data may be analyzed. For example, contact information, such as roles, titles, and departments associated with an account may be analyzed. In some cases, an organization chart or hierarchical chart may be used to analyze contact information. Additionally or alternatively, social media profiles may be used to identify key decision-makers or influencers of an account. Historical interactions may be analyzed to identify who has been involved in previous communications and decision-making processes. Engagement metrics and interaction data may also be evaluated. For example, email-open rates, click-through rates, response rates, event (e.g., webinar, conference, etc.) attendance, social media interactions, user activity (e.g., power users or frequent users), feature adoption (e.g., users adopting new features or advanced features of a product), purchase history, website analytics (e.g., users that visit a target website and content engaged with), etc., may be used to identify individuals actively engaged with campaign content. Any additional data may be analyzed, and embodiments are not intended to be limited herein.

Such data may be used to determine an account(s) with which to engage in association with a campaign. In some cases, AI technology may be used to analyze the data and provide an account(s) recommendation. In this regard, a predictive model may be used to identify a contact(s) most likely to respond positively to outreach or engagement in association with a product(s). In one example, the contact identifier 232 may generate a prompt that includes data relevant to determining a contact. For example, a query, or portion thereof, and an instruction to determine a contact may be provided in a prompt. In addition, in some cases, additional data, such as a portion of operational data, may be included in the prompt to provide context.

The channel identifier 234 is generally configured to identify a channel(s) to use to engage with a contact or account. A channel may refer to a medium or platform used to communicate and engage with a customer or potential customer. Examples of channels include email, social media, direct mail, phone calls, webinars, trade shows, in-person meetings, etc. The particular channel used is important, as it may affect how effectively a contact can be reached and/or influenced. A channel may be identified in any number of cases. For example, in some cases, an account and/or contact to which to sell a product may be identified (e.g., via a query or via an account and/or contact identifier). In such cases, the channel identifier 234 may identify which channel to use to engage or communicate with the account or contact. A channel determination may be directly requested in a query and/or identified as a campaign attribute to determine via the campaign orchestrator 224.

In embodiments, to identify a channel(s) for a campaign, various operational data may be analyzed. For example, engagement metrics may be evaluated. For instance, email-open rates, click-through rates, social media engagement, website traffic, etc., may be analyzed to determine which channels are most effective. Customer interaction data, such as support tickets, chat logs, call records, etc., may be analyzed to identify customer preferences for communication. Sales data may also be analyzed to identify which channels have led to high conversion rates and revenue or the most successful channels for previous campaigns. Product data may also be analyzed, for example, to consider which channel may be best suited for a type of product or service offering. Customer feedback may provide an indication of which channel a customer prefers for obtaining information about a product. Behavior data may also provide analysis to identify a suitable channel(s). For instance, website analytics may provide an indication of a channel(s) that drives the most traffic to a website. As another example, content engagement may indicate which types of content perform best on different channels to tailor the content to the channel. Any additional data may be analyzed, such as industry trends and competitor strategies, and embodiments are not intended to be limited herein.

Such data may be used to determine a channel(s) through which to engage in association with a campaign. In some cases, AI technology may be used to analyze the data and provide a channel(s) recommendation. In this regard, a predictive model may be used to identify a channel(s) likely to perform best based on historical data and current trends. In one example, the channel identifier 234 may generate a prompt that includes data relevant to determining a channel. For example, a query, or portion thereof, and an instruction to determine a channel may be provided in a prompt. In addition, in some cases, additional data, such as a portion of operational data, may be included in the prompt to provide context.

The content identifier 236 is generally configured to identify a content(s) to use to engage with a contact or account (e.g., in association with a product). Content generally refers to any material created to communicate information, engage an audience, and/or support marketing or sales efforts. Content may include blog posts, whitepapers, case studies, videos, webinars, social media posts, talking points, presentations, etc. Generally, effective content addresses needs and interests of a target audience, provides value, and/or fosters engagement. Suitable content to provide or use for engagement may be based on, for example, the contact, account, and/or products selected. Content may be identified in any number of cases. For example, in some cases, an account and/or contact to which to sell a product may be identified (e.g., via a query or via an account and/or contact identifier). In such cases, the content identifier 236 may identify a type of content or content to use to engage or communicate with the account or contact. A content determination may be directly requested in a query and/or identified as a campaign attribute to determine via the campaign orchestrator 224.

In embodiments, to identify a content(s) or type of content for a campaign, various operational data may be analyzed. At a high level, data indicating how the content may be relied upon and/or how the account and/or contact engages (e.g., interests, preferences, etc.) may be analyzed. For example, engagement metrics may be evaluated. For instance, page views, time on page, social shares, and comments etc., may be analyzed to determine which types of content are most engaging. Customer interaction data, such as support tickets, chat logs, call records, etc., may be analyzed to identify common issues that may be addressed through content. Sales data may also be analyzed to identify which content items have contributed to lead generation and conversions. Product data may also be analyzed, for example, to create content that highlights unique features and benefits of a product(s). Product usage data may be used to identify which features are most popular and/or should be emphasized. Customer feedback may provide an indication of what product features customers value, which can be used to guide the creation of content. Behavioral data may also provide analysis to identify content. For instance, website analytics may provide an indication of content that drives the most traffic to and engagement with a website, thereby indicating topics and/or formats that resonate with the audience. As another example, content engagement may indicate which types of content (e.g., blogs, videos, etc.) perform best on different channels to tailor the content. Any additional data may be analyzed, such as industry trends and competitor content, and embodiments are not intended to be limited herein.

As such, the content identifier 236 may obtain or access various operational data to determine a content type and/or content to provide to a customer or potential customer. Thereafter, such data may be used to determine a type(s) of content or content to use to engage in association with a campaign. In some cases, AI technology may be used to analyze the data and provide a content recommendation. In this regard, a predictive model may be used to identify a type of content(s) or content likely to perform best based on historical data and current trends. For example, content topics and content format may be identified for use in generating content. In one example, the content identifier 236 may generate a prompt that includes data relevant to determining content. For example, a query, or portion thereof, and an instruction to determine content may be provided in a prompt. In addition, in some cases, additional data, such as a portion of operational data, may be included in the prompt to provide context.

In some cases, the content identifier 236 may identify a type of content. For example, the content identifier 236 may identify a format for conveying content. Additionally, the content identifier 236 may identify a topic or talking points for content. Such format and/or topics may be provided as a content recommendation. In further embodiments, the content identifier 236 may generate content for communicating to a target audience. For example, in some cases, a type of content and a topic(s) or talking points for content may be provided to a machine learning model, such as a large language model (LLM), to create or generate content in accordance therewith.

As described, in some cases, the content identifier 236 is generally configured to generate content. In this regard, the content identifier 236 analyzes data in the prompt and outputs a content. In this way, the content identifier 236 may generate text, images, videos, combinations thereof, etc. In embodiments, the content identifier 236 takes, as input, a prompt. Based on the prompt, the content identifier 236 can generate content, for example, associated with data included or indicated in the prompt. For instance, assume a prompt includes a query associated with content generation for a campaign, or a portion thereof. In such a case, the content identifier 236 identifies or generates content, such as text and/or images, based on the query and the data identified as relevant to the query included or referenced in the prompt.

The content identifier 236 may be, include, or access any number of AI models or technologies (e.g., generative AI models or technologies). In some embodiments, the AI model is a Large Language Model (LLM). A language model is a statistical and probabilistic tool that determines the probability of a given sequence of words occurring in a sentence (e.g., via next sentence prediction [NSP] or minimal learning machine [MLM]). In this way, it is a tool that is trained to predict the next word in a sentence. A language model is called a large language model when it is trained on an enormous amount of data. Some examples of LLMs are OPT, FLAN-T5, BART, GOOGLE's BERT, and OpenAI's GPT-2, GPT-3, and GPT-4. For instance, GPT-3 is a large language model with 175 billion parameters trained on 570 gigabytes of text. These models have capabilities ranging from writing a simple essay to generating complex computer codes—all with limited to no supervision. Accordingly, an LLM is a deep neural network that is very large (billions to hundreds of billions of parameters) and understands, processes, and produces human natural language by being trained on massive amounts of text. In embodiments, an LLM generates representations of text, acquires world knowledge, and/or develops generative capabilities.

Additionally or alternatively, the content identifier 236 may be in the form of or access a large vision model (LVM) that can interpret and understand visual information. A visual model may be built using a deep learning technique, such as convolutional neural networks (CNNs) and/or transformer models, which are well-suited for tasks involving image recognition, classification, segmentation, object detection, etc. At a high level, a vision model processes visual data in the form of images or videos by extracting features at various levels of abstraction to understand the content. Vision models learn to recognize patterns, shapes, textures, and other visual cues that are relevant to a task. Examples of vision models include Landing AI's LandingLens and Google's Vision Transformer (ViT).

Further, the content identifier 236 may be in the form of or access a multimodal large language model (MLLM) that can interpret and understand visual information. An MLLM generally understands and generates text while also processing and comprehending other modalities, such as images, audio, and/or video. MLLM can associate text with various forms of data, thereby enabling such models to perform tasks that require understanding and synthesis across multiple modalities. Examples of MLLMs include Open AI's GPT-4 Turbo with Vision and Open AI's Contrastive Language-Image Pre-training (CLIP).

As such, as described herein, an LLM, LVM, and/or MLLM, can obtain a prompt and, using such information in the prompt, generate content(s), for instance, for a campaign. Use of LLM, LVM, and/or MLLM may depend on the format of the data to be analyzed and/or the content to be generated. As one example, prompts including only text may be processed via an LLM, and prompts including images may be processed via an LVM and/or MLLM. In some cases, text-based prompts and visual-based prompts may be generated separately such that the text-based prompts are processed by an LLM, while the visual-based prompts are processed via an LVM or MLLM. In other cases, prompts with a visual aspect may be directed to an MLLM. In this way, an MLLM may process both the text-based data and the visual-based data. Accordingly, any number of components may be used to create content.

The post-sales activities identifier 238 is generally configured to identify activities to perform post-sales. Post-sales activities may facilitate maintaining and enhancing customer relationships, ensuring customer satisfaction, and/or driving additional revenue through upselling and cross-selling. Such post-sales activities may include, for example, customer onboarding, customer support, relationship nurturing, upselling, cross-selling, customer feedback, renewals and retention, etc. Customer onboarding refers to helping customers get started with a product or service through training, documentation, and support. Customer support refers to providing ongoing assistance to address any issues or questions that arise after the sale. Relationship nurturing refers to checking in with customers to maintain a strong relationship, understand their evolving needs, and ensure satisfaction with a product or service. Cross-selling refers to offering additional products or services, for example, that may complement what the customer has already purchased. Customer feedback refers to gathering feedback to improve offerings and address concerns. Renewals and retention refers to ensuring customers renew their contracts or subscriptions and remain loyal to the brand.

Post-sales activities may be identified in any number of cases. For example, in some cases, assume a product sale is completed. In such cases, the post-sales activity identifier 238 may identify a type of post-sales activity or an implementation for performing a post-sales activity to use to engage or communicate with an account or contact. A post-sales activity determination may be directly requested in a query and/or identified as a campaign attribute to determine via the campaign orchestrator 224.

In embodiments, to identify a post-sales activity(s) or type of post-sales activity for a campaign, various operational data may be analyzed. For example, for customer onboarding, customer onboarding completion rates and time taken to onboard may be analyzed to identify bottlenecks. Product data, such as usage data, may be analyzed to determine which features customers are using and which features customers are not using. In this way, onboarding materials may be tailored to focus on underutilized features, for example. Personalized onboarding plans may be developed based on customer profiles and usage patterns. In this way, such data may be used to recommend generation or provision of personalized onboarding plans based on customer profiles and usage patterns.

For customer support, support ticket volumes, response times, resolution rates, etc., may be analyzed to identify common issues and peak times for support requests. Product data may be analyzed to identify types of issues reported to understand product weaknesses. Such data may be used to recommend generation or provision of support resources, such as FAQs, knowledge bases, and chatbots.

For relationship nurturing, engagement metrics, such as email-open rates, meeting frequencies, and customer satisfaction scores may be monitored or analyzed. Product usage data may also be used to identify customers highly engaged or at risk of churn. Such data, among others, may be used to recommend generation or provision of scheduling regular check-ins and personalized communications. For instance, a CRM system may be automatically used to track interactions and set reminders for follow-ups.

For upselling and/or cross-selling, purchase history and customer segmentation data may be analyzed to identify opportunities. Further, product data, such as product usage patterns, may be used to identify complementary products or features that may interest a customer. In this way, such data, among other data, may be used to recommend generation or provision of developing content, personalized recommendations, interactions or engagements, channels, etc., for upselling or cross-selling.

For customer feedback, various data may be used to recommend a suggestion to solicit customer feedback. For example, customer feedback may be initiated based on a duration of utilization of a product or usage of the product. In this way, engagement data, among other types of data, may be analyzed to determine to solicit customer feedback.

For renewals and retention, renewal rates, churn rates, customer lifetime value, etc., may be analyzed to identify patterns and predictors of customer retention. Further, product data including product usage data may be used to identify features that correlate with high retention rates. In such cases, the data analysis may result in development of proactive renewal strategies, such as early renewal incentives, personalized retention offers, etc. Any additional data may be analyzed, such as industry trends and competitor content, to identify post-sales activities, and embodiments are not intended to be limited herein.

As such, the post-sales activity identifier 238 may obtain or access various operational data to determine a post-sales activity and/or a type thereof. Thereafter, such data may be used to determine a post-sales activity(s) and/or type thereof to engage with a customer. In some cases, AI technology may be used to analyze the data and provide a post-sales activity recommendation. In this regard, a predictive model may be used to identify a type of post-sales activity(s) or post-sales activity likely to foster an ongoing and/or expanded relationship with the customer. For example, a type of post-sales activity and an implementation thereof may be identified for use in engaging a customer. In one example, the post-sales activity identifier 238 may generate a prompt that includes data relevant to determining content. For example, a query, or portion thereof, and an instruction to determine a post-sales activity may be provided in a prompt. In addition, in some cases, additional data, such as a portion of operational data, may be included in the prompt to provide context.

In some cases, the post-sales activity identifier 238 may identify a type of post-sales activity. For example, the post-sales activity identifier 238 may identify, based on data, a particular customer need and, thereafter, select one or more post-sales activities to perform in accordance therewith. Additionally, the post-sales activity identifier 238 may identify an implementation strategy for the post-sales activity. For example, assume it is determined that customer feedback would be valuable. In such a case, the post-sales activity identifier 238 may, based on various data, determine a set of questions to ask the customer. As another example, assume it is determined to upsell a product. In such a case, the post-sales activity identifier may determine or generate content associated therewith.

A campaign recommendation manager 240 is generally configured to generate and/or provide a campaign recommendation. A campaign recommendation generally refers to a recommendation in association with a campaign. In embodiments, a campaign recommendation may include one or more campaign attributes identified in association with one or more campaign attribute identification components 226-238. Accordingly, a campaign recommendation may include a recommendation related to a goal, an offering, an account, a contact, a channel, a content, and/or a post-sales activity in association with a campaign. In some cases, the campaign recommendation manager 240 aggregates each of the identified campaign attributes to provide a campaign or campaign strategy. In other cases, the campaign recommendation manager 240 may provide a campaign attribute in an ongoing manner. As one example, as campaign attributes are identified, the campaign recommendation manager 240 may provide the campaign attribute. In this way, the campaign attribute may be provided and used in a timely manner. For instance, assume the campaign orchestrator is facilitating campaign attribute identification based on an occurrence of an event (e.g., a response or lack of response from a customer, a content communication via a channel, a sale purchase completion, etc.). In such a case, an identified campaign attribute may be provided to a user such that the user can use or implement the campaign attribute before a subsequent campaign attribute is identified.

In embodiments, the campaign recommendation manager 240 may manage and/or transmit campaign attributes, or data associated therewith, generated via the campaign attribute identification components 226-240. In some cases, such data may be stored, for example, in data store 214, for use in implementing in a campaign, performing subsequent campaign activities, making decisions related to the campaign attributes, etc. Additionally or alternatively, campaign recommendations 260 may be provided to a user device or user for viewing, such as via user device 110 of FIG. 1, or another component for viewing or performing further analysis.

Further, the campaign recommendation manager 240 may use the campaign attributes produced or output to generate or derive additional recommendation data. For instance, in some cases, talking point content may be aggregated with other campaign content. For example, in identifying text content to use as a subject, the text content may be combined with a previously generated image associated with a product. As another example, the campaign recommendation manager 240 may compare different campaign attributes determined and select data to provide in a recommendation. For instance, effectiveness (e.g., represented via a score or ranking) associated with multiple generated campaign attributes may be compared to one another or ranked, and the highest effective campaign attribute may be recommended or suggested for use.

In some embodiments, the campaign recommendation manager 240 may analyze the campaign attributes and initiate a new or different campaign attribute determination. For instance, based on a response, feedback, or event occurrence associated with a first campaign attribute, the campaign recommendation manager 240 may trigger the campaign orchestrator 224 to generate a new campaign attribute with a different instruction or based on different data. For instance, assume a first channel is identified for communicating a first content to a potential customer. Based on a lack of feedback and a time duration awaiting a response, a new channel and/or content may be identified for a subsequent communication. Determining a scope for a new or different campaign attribute may be performed in any number of ways. In some cases, a pattern, template, or hierarchical structure may be employed to identify a subsequent set of data to use in generating a subsequent campaign attribute. In other cases, AI technology may be used to facilitate generation of a subsequent campaign attribute scope to pursue.

Campaign recommendations 260 may be presented, via a user interface, in any number of ways. As one example, campaign recommendations may be presented in association with a query, a campaign, a score (e.g., effectiveness score), etc. In this way, a user may select to view a campaign recommendation associated with a particular query(s). In response, the user interface may present content generated in association with a query. Although examples herein provide the campaign recommendations in response to a query, a query may not be needed to trigger campaign recommendations. For example, generation of campaign recommendations may be initiated based on an occurrence of an event or other manner. For example, based on identifying a response to content or lack of response to content, a campaign recommendation may be generated.

As can be appreciated, any number or type of campaign recommendation may be generated, and embodiments described herein are not intended to limit the type of campaign recommendation that may be requested or produced. Further, various implementations may be used to generate campaign attributes(s) in accordance with various operational data. Any number of implementations may be employed in accordance with embodiments described herein.

By way of example only, assume a query includes a target product to sell. In such a case, the campaign manager 212 may identify an account that has a highest propensity to sell the product. To do so, account data may be analyzed to identify a most valued account for the target product. As another example, assume a query indicates a target product to sell to a target account. In such a case, the campaign manager 212 may identify a contact with the target account that is most likely to facilitate a sale of the product. As another example, assume a query indicates a product for which a goal is to increase the number of subscribers by 10 business accounts. In such a case, the campaign manager 212 may identify 10 business accounts to recommend. In addition, a contact may be identified for each account based on analysis of various operational data. For each account, a set of talking points may also be identified for the initial discussion or provision of content. In yet another example, a query may include an indication of a target account, and the campaign manager 212 may identify a target product and a series of communications and corresponding channels to reach out to a contact or set of contacts of the target account.

Although the campaign manager 212 is generally described in relation to identifying campaign attributes for a B2B campaign, the campaign manager 212 may be used in any number of environments or systems to identify campaign attributes.

### Exemplary Implementations for Facilitating Automated Campaign Generation Via a Campaign Orchestrator

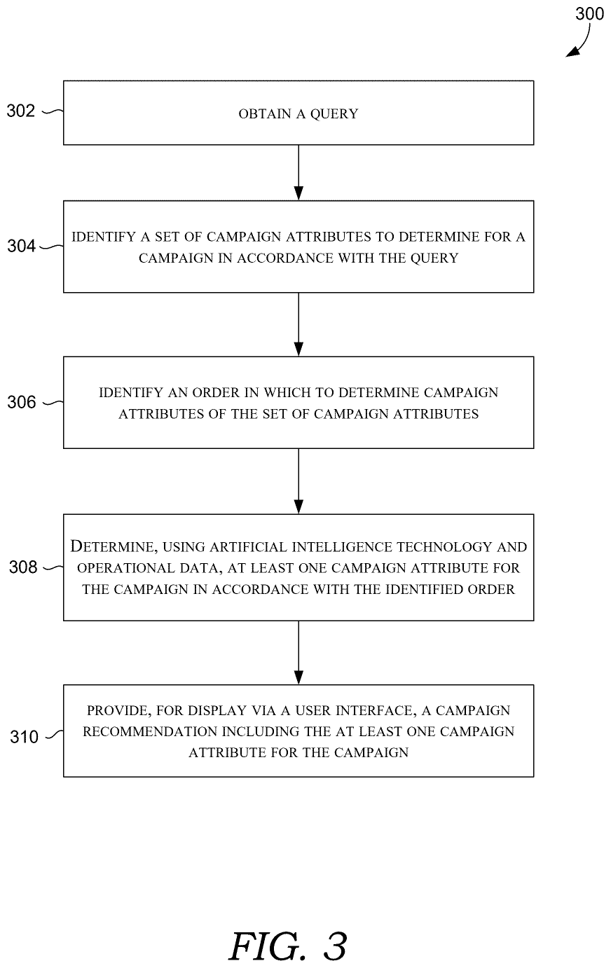

As described, various implementations can be used in accordance with embodiments described herein. FIGS. 3-5 provide methods of facilitating automated campaign generation via a campaign orchestrator, in accordance with embodiments described herein. The methods 300, 400, and 500 can be performed by a computer device, such as device 600 described below. The flow diagrams represented in FIGS. 3-5 are intended to be exemplary in nature and not limiting.

Turning initially to method 300 of FIG. 3, method 300 is directed to one implementation of facilitating automated campaign generation via a campaign orchestrator, in accordance with embodiments described herein. Initially, at block 302, a query is obtained. A query may be provided by a user at a user device.

At block 304, a set of campaign attributes to determine for a campaign in accordance with the query is identified. A set of campaign attributes can be identified in any number of ways. As one example, campaign attributes may be identified based on analysis of the query, operational data, and/or the like.

At block 306, an order in which to determine campaign attributes of the set of campaign attributes is identified. In some embodiments, a timing may additionally be identified for determining campaign attributes. For example, a particular date or a preceding occurrence of an event may be specified. Operational data may be any type of data that may facilitate identifying campaign attributes. For example, operational data includes firmographics data, engagement data, product data, and/or customer data. Such operational data may, in some embodiments, be selected and obtained based on relevance to the campaign attribute. The set of campaign attributes may be identified using a rule-based approach, a heuristics-based approach, a machine learning model, and/or the like.

At block 308, using artificial intelligence technology and operational data, at least one campaign attribute for the campaign is determined in accordance with the identified order. In embodiments, the campaign attribute may include a goal, an offering, an account, a contact, a channel, a content, or a post-sales activity. In some cases, the campaign attribute is determined based on a result of a prior campaign attribute determination.

At block 310, a campaign recommendation is provided, for display via a user interface, wherein the campaign recommendation includes the at least one campaign attribute for the campaign.

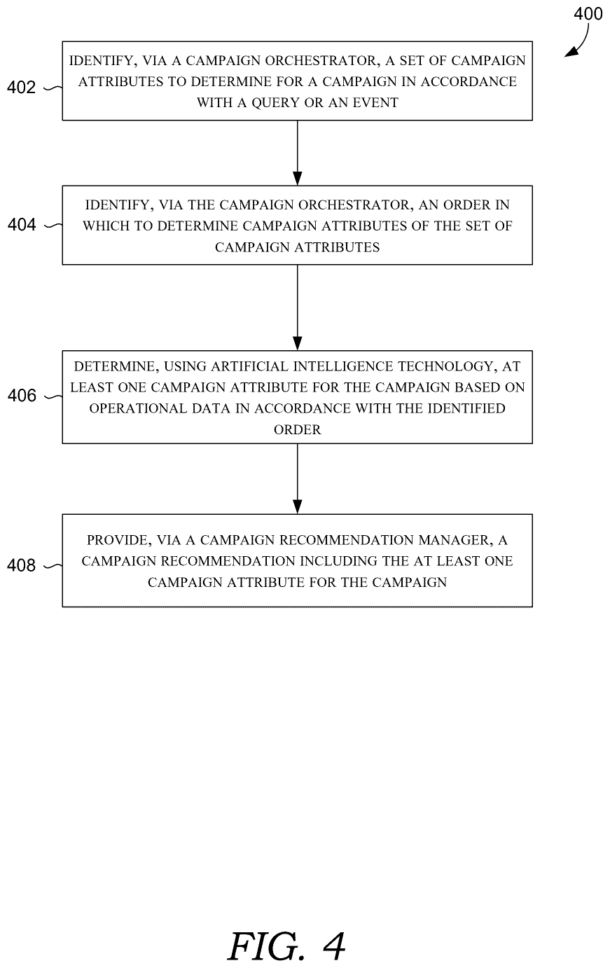

Turning to FIG. 4, method 400 of FIG. 4 is directed to another example implementation of facilitating automated campaign generation via a campaign orchestrator, in accordance with embodiments described herein. Initially, at block 402, a set of campaign attributes to determine for a campaign is identified, via a campaign orchestrator, in accordance with a query or an event. In this regard, a query may be received and/or an occurrence of an event identified. In some cases, identifying the set of campaign attributes may include identifying a first campaign attribute to determine and a second campaign attribute to determine.

At block 404, an order in which to determine campaign attributes of the set of campaign attributes is identified via the campaign orchestrator. In some cases, an order in which to determine the campaign attributes is based on the query or an occurrence of the event.

At block 406, at least one campaign attribute for the campaign is determined, using AI technology, based on operational data in accordance with the identified order. Operational data may include firmographics data, engagement data, product data, and/or customer data. The campaign attribute may be a goal, an offering, an account, a contact, a channel, a content, or a post-sales activity.

At block 408, a campaign recommendation including the at least one campaign attribute for the campaign is provided, via a campaign recommendation manager. For example, a campaign recommendation may be provided for display at a user device.

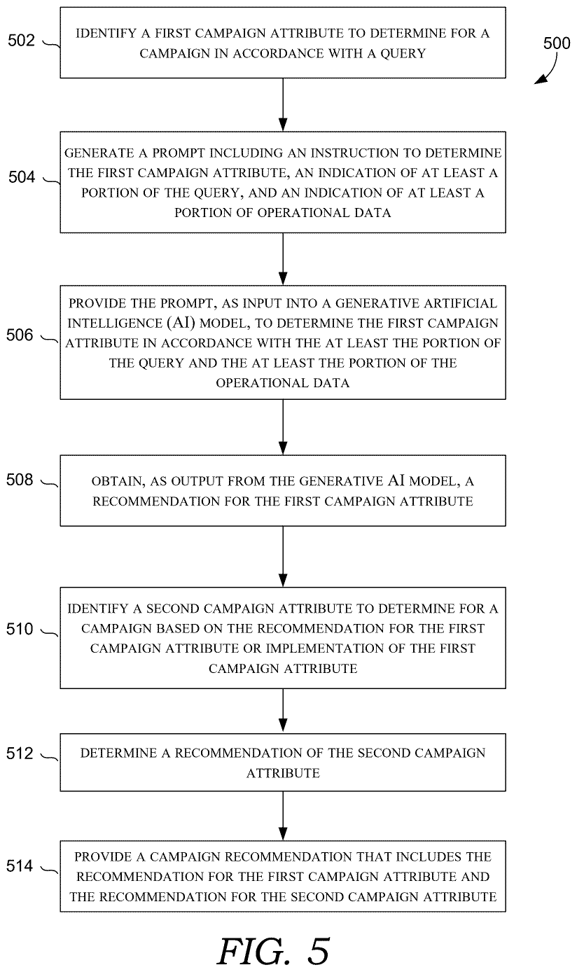

With reference now to FIG. 5, method 500 of FIG. 5 is directed to another example implementation of facilitating automated campaign generation via a campaign orchestrator, in accordance with embodiments described herein. At block 502, a first campaign attribute to determine for a campaign is identified in accordance with a query. The first campaign attribute may be one of a goal, an offering, an account, a contact, a channel, a content, or a post-sales activity.

At block 504, a prompt including an instruction to determine the first campaign attribute, an indication of at least a portion of the query, and an indication of at least a portion of operational data is generated. In some embodiments, the operational data to use in the prompt is selected based on relevance to the first campaign attribute.

At block 506, the prompt is provided, as input into a generative artificial intelligence (AI) model, to determine the first campaign attribute in accordance with the at least the portion of the query and the at least the portion of the operational data. Thereafter, at block 508, output from the generative AI model is obtained as a recommendation for the first campaign attribute.

At block 510, a second campaign attribute to determine for a campaign is identified based on the recommendation for the first campaign attribute or implementation of the first campaign attribute. For example, the subsequent campaign attribute to determine is identified based on the prior identified campaign attribute or execution of the campaign attribution (or response thereto).

At block 512, a recommendation of the second campaign attribute is determined. In some cases, such a recommendation for a second campaign attribute may be generated using the generative AI model. For example, in cases in which a suitable channel is being determined, an email channel recommendation may be determined or generated using the generative AI model. At block 514, a campaign recommendation that includes the recommendation for the first campaign attribute and the recommendation for the second campaign attribute is provided. In embodiments, the campaign recommendation is provided for display at a user device.

### Overview of an Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 6 in particular, an exemplary operating environment for implementing aspects of the technology described herein is shown and designated generally as computing device 600. Computing device 600 is just one example of a suitable computing environment and is not intended to suggest any limitation as to the scope of use or functionality of the technology described herein, and nor should the computing device 600 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 6, computing device 600 includes a bus 610 that directly or indirectly couples the following devices: memory 612, one or more processors 614, one or more presentation components 616, input/output (I/O) ports 618, I/O components 620, an illustrative power supply 622, and a radio(s) 624. Bus 610 represents what may be one or more buses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 6 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 6 and refer to “computer” or “computing device.”

Computing device 600 typically includes a variety of computer-readable media. Computer-readable media can be any available media that can be accessed by computing device 600 and includes both volatile and non-volatile, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVDs) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 612 includes computer storage media in the form of volatile and/or non-volatile memory. The memory 612 may be removable, non-removable, or a combination thereof. Exemplary memory includes solid-state memory, hard drives, and optical-disc drives. Computing device 600 includes one or more processors 614 that read data from various entities such as bus 610, memory 612, or I/O components 620. Presentation component(s) 616 present data indications to a user or other device. Exemplary presentation components 616 include a display device, speaker, printing component, and vibrating component. I/O port(s) 618 allow computing device 600 to be logically coupled to other devices including I/O components 620, some of which may be built-in.

Illustrative I/O components include a microphone, joystick, game pad, satellite dish, scanner, printer, display device, wireless device, a controller (such as a keyboard and a mouse), a natural user interface (NUI) (such as touch interaction, pen [or stylus] gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 614 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 600. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as stereoscopic camera systems, infrared camera systems, RGB camera systems, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

A computing device may include radio(s) 624. The radio 624 transmits and receives radio communications. The computing device may be a wireless terminal adapted to receive communications and media over various wireless networks. Computing device 600 may communicate via wireless protocols, such as code-division multiple access (“CDMA”), global system for mobiles (“GSM”), or time-division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive.

1. One or more computer storage media having computer-executable instructions embodied thereon that, when executed by one or more processors, cause the one or more processors to perform a method, the method comprising:
obtaining a query;
identifying a set of campaign attributes, from among a plurality of campaign attributes, to determine for a campaign based on analysis of the query and operational data associated with at least one entity and obtained from a data source via a network;
identifying an order in which to determine campaign attributes of the set of campaign attributes based on analysis of the query and the operational data;
determining, using artificial intelligence technology and the operational data, at least one campaign attribute for the campaign in accordance with the identified order such that a first campaign attribute is determined and used to determine a subsequent second campaign attribute, wherein determining the at least one campaign attribute for the campaign comprises generating a prompt including the query and at least a portion of the operational data and providing the prompt as input to the artificial intelligence technology; and
providing, for display via a user interface, a campaign recommendation including the at least one campaign attribute for the campaign.

2. The media of claim 1, wherein the at least one campaign attribute comprises a goal, an offering, an account, a contact, a channel, a content, or a post-sales activity.

3. The media of claim 1, further comprising a timing for determining campaign attributes of the set of campaign attributes.

4. The media of claim 1, wherein the operational data includes firmographics data, engagement data, product data, and/or customer data.

5. The media of claim 1, wherein the set of campaign attributes is identified based on a rule-based approach, a heuristics-based approach, or a machine learning model.

6. The media of claim 1, wherein the at least one campaign attribute is determined based on a result of a prior campaign attribute determination.

7. The media of claim 1, further comprising selecting and obtaining the operational data relevant to determining the at least one campaign attribute.

8. The media of claim 1, wherein identifying the set of campaign attributes comprises identifying the first campaign attribute to determine and the second campaign attribute to determine, and wherein identifying the order comprises identifying the first campaign attribute followed by the second campaign attribute.

9. A computer-implemented method comprising:
identifying, via a campaign orchestrator, a set of campaign attributes to determine for a campaign in accordance with a query or an event;
identifying, via the campaign orchestrator, an order in which to determine campaign attributes of the set of campaign attributes;
determining, using artificial intelligence technology, at least one campaign attribute for the campaign based on operational data in accordance with the identified order, wherein determining the at least one campaign attribute for the campaign comprises generating a prompt including the query and the operational data and providing the prompt as input to the artificial intelligence technology, the operational data including firmographics data, engagement data, product data. and/or customer data; and
providing, via a campaign recommendation manager, a campaign recommendation including the at least one campaign attribute for the campaign.

10. The method of claim 9, further comprising receiving the query or identifying an occurrence of the event.

11. The method of claim 9, wherein the order in which to determine the campaign attributes is based on the query or an occurrence of the event.

12. (canceled)

13. The method of claim 9, wherein the at least one campaign attribute comprises a goal, an offering, an account, a contact, a channel, a content, or a post-sales activity.

14. The method of claim 9, wherein identifying the set of campaign attributes comprises identifying a first campaign attribute to determine and a second campaign attribute to determine, and wherein identifying the order comprises identifying the first campaign attribute followed by the second campaign attribute.

15. A computing system comprising:
a processor; and
one or more computer storage media storing computer-useable instructions that, when used by the one or more processors, cause the one or more processors to perform operations comprising:
identifying a first campaign attribute to determine for a campaign in accordance with a query;
generating a prompt including an instruction to determine the first campaign attribute, an indication of at least a portion of the query, and an indication of at least a portion of operational data;
providing the prompt, as input into a generative artificial intelligence (AI) model, to determine the first campaign attribute in accordance with the at least the portion of the query and the at least the portion of the operational data;
obtaining, as output from the generative AI model, a recommendation for the first campaign attribute;
identifying a second campaign attribute to determine for a campaign based on the recommendation for the first campaign attribute or implementation of the first campaign attribute;
determining a recommendation of the second campaign attribute; and
providing a campaign recommendation that includes the recommendation for the first campaign attribute and the recommendation for the second campaign attribute.

16. The system of claim 15, wherein the campaign attribute is provided for display at a user device.

17. The system of claim 15, further comprising identifying a timing in which to determine the first campaign attribute and generating the prompt in accordance with the timing.

18. The system of claim 15, wherein the first campaign attribute comprises one of a goal, an offering, an account, a contact, a channel, a content, or a post-sales activity, and the second campaign attribute comprises a different one of the goal, the offering, the account, the contact, the channel, the content, or the post-sales activity.

19. The system of claim 15, wherein the recommendation of the second campaign attribute is generated using the generative AI model.

20. The system of claim 15, wherein the at least the portion of the operational data is selected for the prompt based on relevance to the first campaign attribute.
